(19) United States
(12) Patent Application Publication
(10) Pub. No.: US 2009/0182812 A1
(43) Pub. Date: Jul. 16, 2009

(54) METHOD AND APPARATUS FOR DYNAMIC SCALING OF DATA CENTER PROCESSOR UTILIZATION

(76) Inventors: Paritosh Bajpay, Edison, NJ (US); Stephen Griesmer, Westfield, NJ (US); Monowar Hossain, Middletown, NJ (US); Thiru Ilango, Holmdel, NJ (US); Arun Kandappan, Morganville, NJ (US); Kenneth Oexmann, Manalapan, NJ (US); Venkatesh Patrachari, Morganville, NJ (US); Steve Van Pelt, Brick, NJ (US); Joyce Weekley, Cincinnati, OH (US); Chen-Yui Yang, Marlboro, NJ (US)

Correspondence Address: AT & T LEGAL DEPARTMENT - WT, PATENT DOCKETING, ROOM 2A-207, ONE AT& T WAY, BEDMINSTER, NJ, 07921, US

(21) Appl. No.: 12/013,861

(22) Filed: Jan. 14, 2008

(51) Int. Cl. G06F 15/16

(52) U.S. Cl. 709/205

(57) ABSTRACT

In one embodiment, the present invention is a method and apparatus for dynamic scaling data center of processor utilization. In one embodiment, a system for managing a data center includes a control module for gathering data related to at least one server in the data center, the data being gathered from a plurality of sources, and a user interface coupled to the control module for displaying the gathered data to a user in a centralized manner. The control module is further configured to receive a command from the user, the command relating to the operation of the server, and to transmit the command to server.

### FIELD OF THE INVENTION

The present invention relates generally to data centers and relates more particularly to the management of data center energy consumption.

Data center energy consumption (e.g., for power and cooling) has come under increasing scrutiny in recent years, as the energy consumed by data centers (and, correspondingly, the costs associated with operating the data centers) has steadily increased. Specifically, significant kilowatt hours typically expended each year in data centers can be saved by optimizing energy conservation efforts. For this reason, rebates, energy credits, and other incentives for reducing energy consumption are becoming more prevalent. It has therefore become more important to enable data center users to conserve energy whenever and wherever possible.

Currently, however, the availability of data used to make energy conservation decisions (e.g., scaling of processor utilization during certain time periods) is hindered by the fact that the data resides in numerous fragmented sources (or does not even exist). This makes it difficult for data center users to make timely and informed decisions regarding processor usage and cooling.

Thus, there is a need in the art for a method and apparatus for dynamic scaling of data center processor utilization in data centers.

### SUMMARY OF THE INVENTION

In one embodiment, the present invention is a method and apparatus for dynamic scaling of data center processor utilization. In one embodiment, a system for managing a data center includes a control module for gathering data related to at least one server in the data center, the data being gathered from a plurality of sources, and a user interface coupled to the control module for displaying the gathered data to a user in a centralized manner. The control module is further configured to receive a command from the user, the command relating to the operation of the server, and to transmit the command to server.

### BRIEF DESCRIPTION OF THE DRAWINGS

The teaching of the present invention can be readily understood by considering the following detailed description in conjunction with the accompanying drawings, in which:

FIG. 1 is a schematic diagram illustrating one embodiment of a system 100 for managing a data center, according to the present invention;

FIG. 2 is a flow diagram illustrating one embodiment of a method for remotely managing a data center, according to the present invention;

FIG. 3 is a schematic diagram illustrating one embodiment of a user interface display, according to the present invention; and

FIG. 4 is a high level block diagram of the data center management method that is implemented using a general purpose computing device.

To facilitate understanding, identical reference numerals have been used, where possible, to designate identical elements that are common to the figures.

### DETAILED DESCRIPTION

In one embodiment, the present invention is method and apparatus for dynamic scaling of central processing unit (CPU) utilization in data centers. Embodiments of the invention provide data center users with a centralized view of real-time and historical data to aid in the scaling of processor usage. Further embodiments of the invention provide remote access for dynamic processor scaling. The present invention therefore provides support for energy-saving measures and pro-actively supplements expected business and governmental incentives.

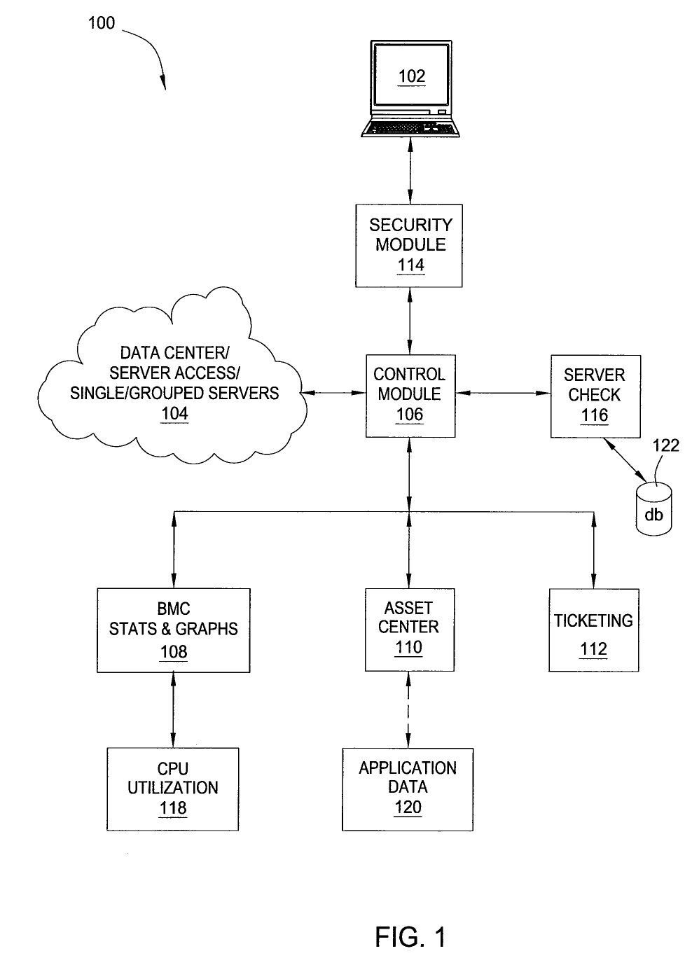

FIG. 1 is a schematic diagram illustrating one embodiment of a system 100 for managing a data center 104, according to the present invention. As illustrated, the main components of the system 100 include a “dashboard” or user interface 102, and a control module 106. The user interface 102 allows a user (e.g., a system administrator) to view data provided by the control module 106 (e.g., reports) and to access the control module 106 for management of servers in the data center 104 (e.g., sleep mode, activate, power up/down, etc.).

In one embodiment, the data center 104 comprises a plurality of resources, including, for example, single and/or grouped servers. In a further embodiment, the data center 104 additionally comprises redundant or backup power supplies, redundant data communications connections, environmental controls (e.g., air conditioning, fire suppression, etc.), and special security devices.

In one embodiment, the control module 106 incorporates management functionality and data collection from a across a plurality of applications, systems, networks, and multi-vendor products and platforms supported by the data center 104. In one embodiment, the control module collects data (historical and real-time) directly from individual servers in the data center 104 and from applications in a server check and application information module 116. The server check and application information module 116 allows the control module 106 to perform real-time fault checks on individual servers in the data center 104 (e.g., by pinging the servers to see if the servers respond). In addition, the server check and application module 116 allows the control module 106 to issue real-time commands to individual servers in the data center 104 (e.g., sleep mode, activate, power up/down, etc.). In one embodiment, these commands can be configured to issue on demand, on a pre-defined schedule, or in an automated manner (e.g., in response to a predefined event). Commands may be customized to platform.

The server check and application information module may be further coupled to a database 122 that stores historical server application information and reports. In one embodiment, the server application information includes at least one of: qualified servers with user permissions, energy usage or savings calculations (e.g., kilowatt hours by state dollar amount), server use (e.g., test, disaster recovery, etc.), server priority numbers (e.g., based on use for restoration), rules (customized to server use), contact names and numbers (e.g., system administrator, application users, etc.), report capability (e.g., scheduled, ad hoc, etc.), supplemental information (e.g., location, notes, specifications, etc.), alert notification (e.g., faults, CPU threshold information, etc.), and cooling sector information.

In a further embodiment, the control module 106 collects data from several other sources, including: a baseboard management controller (BMC) 108, an asset center 110, and a ticketing system 112.

In one embodiment, the BMC 108 generates statistics and/or graphs indicative of server usage in the data center 104. For instance, the BMC provides data relating to historical and current (real-time) CPU utilization during peak and off-peak time periods. To this end, the BMC is communicatively coupled to a central processing unit CPU utilization module 118 that continually monitors the usage of server CPUs.

In one embodiment, the asset center 110 is a repository of detailed information about all of the servers in the data center 104. That is, the asset center comprises a data center inventory. In one embodiment, the asset center 110 stores at least one of the following types of data for each server in the data center 104: server name, serial number, internet protocol (IP) address, server type, system administrator contact information, location, and status (e.g., active, retired, etc.). In one embodiment, this data is added to the asset center 102 when new inventory is added (e.g., preceding installation or shortly thereafter). In one embodiment, updates to this data are performed in substantially real time.

The asset center 110 is communicatively coupled to an application data module 120 that continually tracks information about applications using the data center 104. The application data module 102 cross-references application information that will assist in the identification of how the servers in the data center 104 are being used. In one embodiment, the information tracked by the application data module 102 includes at least one of the following types of information for each application: application lookup information (e.g., the actual application name corresponding to an acronym), application description, and application stakeholders.

In one embodiment, the ticketing system 112 generates tickets indicative of abnormal events occurring in the data center 104. In a further embodiment, the ticketing system 112 correlates tickets in order to identify the root causes of abnormal events and reduce redundancy in date (e.g., a plurality of similar tickets may be related to the same event). In one embodiment, the ticketing system 112 operates in substantially real time to allow for timely corrective action.

In one embodiment, the user interface 102 is a graphical user interface (GUI) that displays the data collected by the control module 106 in a centralized manner in substantially real time. The user interface 102 also allows the user to access the server control functions (e.g., sleep mode, activate, power up/down) supported by the control module 106.

The user interface 102 is communicatively coupled to the control module 106 via a security module 114. The security module 114 is configured to provide a plurality of functions, including: authentication, authorization, least privilege, audit logging, retention, review, timeouts, and warning messages. In one embodiment, the security module 114 uses a platform for user authentication that complies with Active Server Pages Resource (ASPR) policies for authentication, inactivity, and password management items. In one embodiment, the security module 114 provides user authorization in accordance with a plurality of privilege levels (defined, e.g., by function, data center, asset/server, or access level (read, read/write, etc.)). In one embodiment, the security module 114 limits all access to the data center resources to only the commands, data and systems necessary to perform authorized functions. In one embodiment, the security module 114 uses a platform for audit logging, retention, and review that complies with ASPR policies for qualifying events (e.g., field logging). In one embodiment, the security module 114 retains audit logs for a predefined minimum period of time (e.g., x days) or for a required period of time specified by a given business. In a further embodiment, the security module 114 reviews audit logs on a periodic basis (e.g., weekly). In one embodiment, the security module 114 incorporates policies for session handling that destroy session IDs at logout and/or timeout. In one embodiment, the security module 114 issues a login warning notice at every successful application login.

The system 100 therefore allows a user to view (i.e., via the user interface 102) a centralized display of server usage and conditions across the data center 104, regardless of vendor or source. This allows the user to quickly make more informed decisions regarding current and future server usage and cooling. Moreover, the system 100 allows the user to dynamically carry out any decisions regarding server usage/scaling by controlling the usage levels of servers or groups of servers. The data provided by the system 100 will also help expedite virtualization, consolidation, and the control of cooling costs. For instance, a user may choose, based on the data provided, to move applications that share CPU and disk utilization or to stack servers and move the stacked servers to optimal cooling sectors.

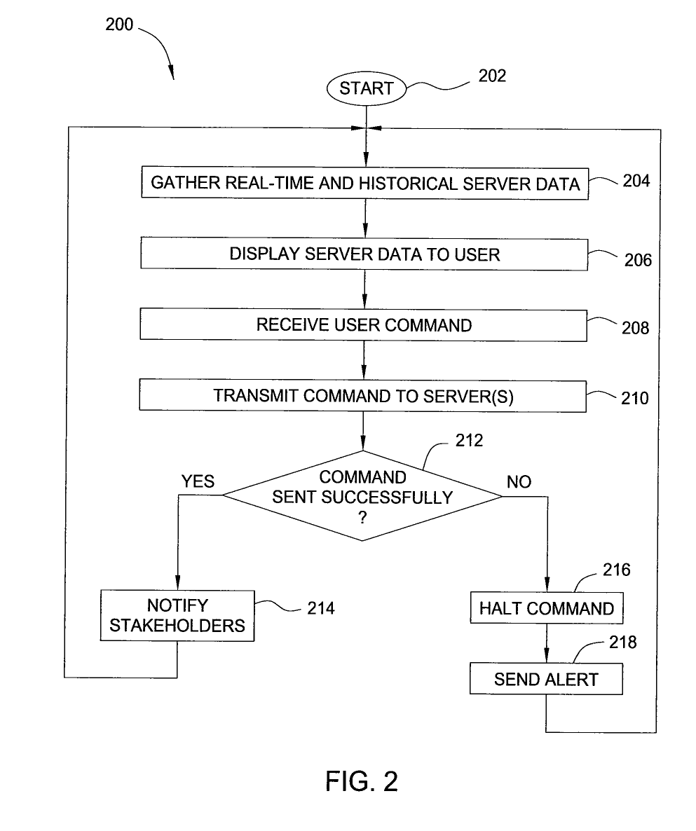

FIG. 2 is a flow diagram illustrating one embodiment of a method 200 for remotely managing a data center, according to the present invention. The method 200 may be implemented, for example, by the control module 106 of the system 100 illustrated in FIG. 1.

The method 200 is initialized at step 202 and proceeds to step 204, where the control module gathers real-time and historical data regarding usage of servers in the data center. As discussed above, in one embodiment, this data is collected from a plurality of sources.

In step 206, the user interface displays the collected data (optionally processed and presented in report form) to a user. In step 208, the control module receives a command from a user (via the user interface) to manage one or more servers in the data center. In one embodiment, the command requires one of the following actions to be taken with respect to the indicated server(s): quiesce, scale, power down, resume, or reactivate. In one embodiment, the command indicates that the required action should be performed substantially immediately (i.e., on demand). In another embodiment, the command indicates that the required action should be performed according to a predefined schedule. In another embodiment, the command indicates that the required action should be automated (e.g., in response to a predefined event).

In step 210, the control module transmits the command to the server(s) indicated. In one embodiment, the command is transmitted on demand (i.e., as soon as the command is received). In another embodiment, the command is transmitted in accordance with a schedule or in an automated manner, as discussed above. In one embodiment, the control module sends user commands to the server(s) only if the commands satisfy a set of one or more predefined rules. In one embodiment, these rules are based on one or more of the following: application owner permission (e.g., required for dates/times to allow or block activities for quiescent and reactivation commands), priority number (e.g., based on use of server, such as production, disaster recovery, test load and soak, etc.), category (e.g., based on use of server for restoration, such as production, disaster recovery, test, database, etc.), fault check (e.g., the command is halted if a fault is detected, as discussed above), CPU threshold peak/off peak utilization (configurable), disk space thresholds (configurable), cooling sector peak/off peak times, priority, and anomalies data, and special requirements and anomaly condition information.

In step 212, the control module determines whether the command was sent to the server(s) successfully. If the control module concludes in step 212 that the command was sent successfully, the method 200 proceeds to step 214, where the control module notifies the stakeholders of all affected applications. The method 200 then returns to step 204, where the control module continues to real-time and historical data regarding usage of servers in the data center.

Alternatively, if the control module concludes in step 212 that the command was not sent successfully (i.e., a fault is detected with the server(s)), the method 200 proceeds to step 216, where the control module halts the command. The method 200 then proceeds to step 218, where the control module sends an alert notification to key personnel (e.g., system administrators). The method 200 then returns to step 204, where the control module continues to real-time and historical data regarding usage of servers in the data center.

In further embodiments, the command received in step 208 comprises a user override. In this case, the control module will notify the stakeholders of any affected applications of the override. In a further embodiment still, the control module enables hold and retract capabilities. In this case, the control module will notify the stakeholders of any affected applications if a hold is placed on an activity.

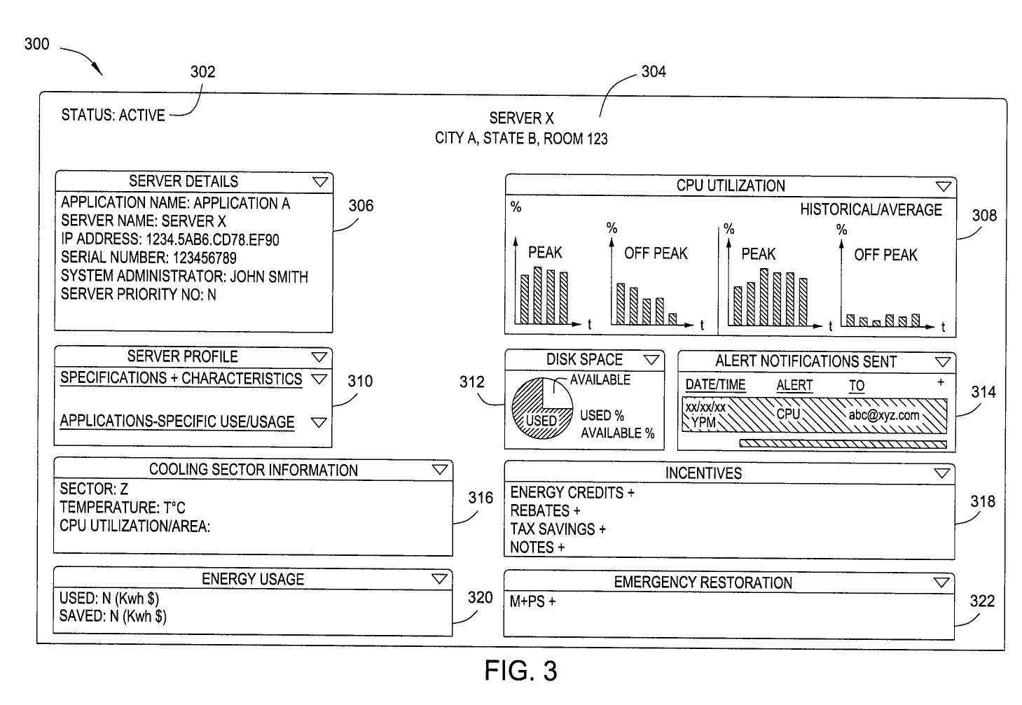

FIG. 3 is a schematic diagram illustrating one embodiment of a user interface display 300, according to the present invention. The display 300 may be displayed, for example, by the user interface 102 illustrated in FIG. 1.

As illustrated, the display 300 displays a variety of textual and graphical information for selected individual, clustered, or grouped servers. In the exemplary embodiment of FIG. 3, the display 300 displays information for an individual server designated as Server A.

As illustrated, the display 300 includes a plurality of menus containing various types of information about the selected server(s). In one embodiment, these menus include: a status menu 302, a location menu 304, a server details menu 306, a CPU utilization menu 308, a server profile menu 310, a disk space menu 312, an alert notification menu 314, a cooling sector menu 316, an incentives menu 318, an energy usage menu 320, and an emergency restoration menu 322.

The status menu 302 provides the status of the selected server (e.g., active, in service, fault, etc.). The location menu 304 provides the location of the selected server (e.g., city, state, room, etc.). The server details menu 306 provides at least one of: the name of an application running on the server, the name of the server, the Internet Protocol (IP) address of the server, the serial number of the server, the server's system administrator, and the server's priority number (e.g., where the lowest priority servers are used for load and soak testing and the highest priority servers are used for disaster recovery and/or hot swap).

The CPU utilization menu 308 provides the percentage of CPU capacity utilized during peak and off peak hours, both currently and historically. In one embodiment, the information displayed by the CPU utilization menu 308 includes graphical analysis. The server profile menu 310 provides server specifications and characteristics (e.g., temperature information), as well as data on application-specific usage of the server.

The disk space menu 312 provides the percentage of disk space that is currently in use and the percentage of disk space that is currently available. In one embodiment, the information displayed by the disk space menu 312 includes graphical analysis. The alert notification menu 314 provides a list of alert notifications that have been sent to impacted application group stakeholders. In one embodiment, the list includes, for each alert notification: the subject fault, the name of the individual(s) to whom the alert notification was sent, and contact information for the individual(s) to whom the alert notification was sent.

The cooling sector menu 316 provides cooling sector information (e.g., for stacking). In one embodiment, this information includes server specifications (e.g., temperature), CPU utilization related to application usage, and other cooling related information for grouping (e.g., location, area, power access data, etc.). This information enables a user to determine cooling needs by geographic location (e.g., including specific room area), to determine an optimal arrangement for moving servers to groups (e.g., for separation and isolation determined by type and time of usage).

The incentives menu 318 provides information on incentives (e.g., energy credits, rebates, tax savings, etc.) that may be available. The energy usage menu 320 provides estimated energy cost and savings calculations (e.g., in cost per kilowatt hour, by state) for the selected server. In one embodiment, these calculations are based on at least one of the following: estimated dollar savings per unit of energy by state (may require initial physical measurements), estimated cooling savings (e.g., year-to-date, monthly, weekly, daily, by fiscal year, etc.), rebates, government incentives, energy credits, hardware depreciation, and pre-retirement power downs and retired servers from node reductions. The emergency restoration menu 322 provides data for emergency restoration (e.g., for resuming activation after a failure occurs.

The display 300 therefore provides real-time and historical data in a centralized manner, allowing for quick analysis across applications, systems, networks, and multi-vendor platforms. The immediate visibility of more precise server data better assists in the decision process for virtualization, consolidation, and the configuration of cooling sectors (e.g., for stacking and moving of servers to optimal clusters).

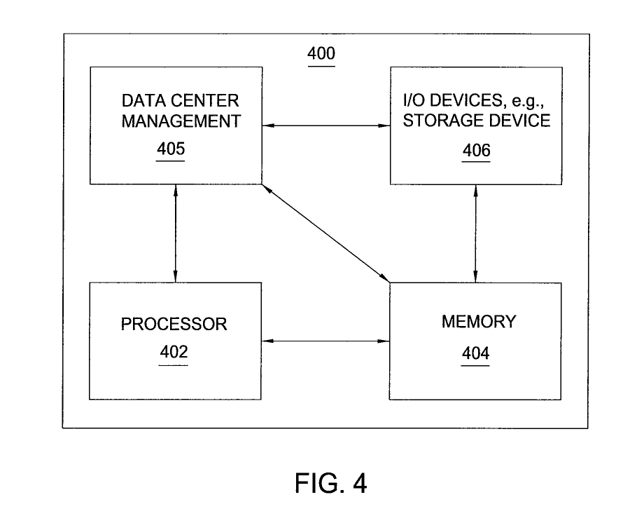

FIG. 4 is a high level block diagram of the data center management method that is implemented using a general purpose computing device 400. In one embodiment, a general purpose computing device 400 comprises a processor 402, a memory 404, a data center management module 405 and various input/output (I/O) devices 406 such as a display, a keyboard, a mouse, a modem, and the like. In one embodiment, at least one I/O device is a storage device (e.g., a disk drive, an optical disk drive, a floppy disk drive). It should be understood that the data center management module 405 can be implemented as a physical device or subsystem that is coupled to a processor through a communication channel.

Alternatively, the data center management module 405 can be represented by one or more software applications (or even a combination of software and hardware, e.g., using Application Specific Integrated Circuits (ASIC)), where the software is loaded from a storage medium (e.g., I/O devices 406) and operated by the processor 402 in the memory 404 of the general purpose computing device 400. Thus, in one embodiment, the data center management module 405 for managing data center resources described herein with reference to the preceding Figures can be stored on a computer readable medium or carrier (e.g., RAM, magnetic or optical drive or diskette, and the like).

It should be noted that although not explicitly specified, one or more steps of the methods described herein may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in the accompanying Figures that recite a determining operation or involve a decision, do not necessarily require that both branches of the determining operation be practiced. In other words, one of the branches of the determining operation can be deemed as an optional step.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for managing a data center, comprising:
gathering data related to at least one server in the data center, the data being gathered from a plurality of sources;
displaying the gathered data to a user in a centralized manner;
receiving a command from the user, the command relating to the operation of the at least one server; and
transmitting the command to the at least one server.

2. The method of claim 1, wherein the gathered data includes historical data and substantially real-time data.

3. The method of claim 1, wherein the gathered data includes at least one of: server fault check data, energy use calculations, energy savings calculations, server use data, server priority numbers, system administrator contacts, application user contacts, report capability information, server location information, alert notification information, cooling sector information, disk space usage data, CPU utilization data, incentive data, and server specification data.

4. The method of claim 1, wherein the gathered data is displayed in the form of one or more reports.

5. The method of claim 4, wherein the one or more reports include textual and graphical data.

6. The method of claim 1, wherein the command is: quiesce, scale, power down, resume, or reactivate.

7. The method of claim 1, wherein the command is transmitted on demand.

8. The method of claim 1, wherein the command is transmitted in accordance with a pre-defined schedule.

9. The method of claim 1, wherein the command is transmitted in an automated manner.

10. The method of claim 1, further comprising:
notifying stakeholders when the command is successfully sent.

11. The method of claim 1, further comprising:
halting the command when the command cannot be successfully sent; and
generating an alert indicative of the halted command.

12. A computer readable medium containing an executable program for managing a data center, where the program performs the steps of:
gathering data related to at least one server in the data center, the data being gathered from a plurality of sources;
displaying the gathered data to a user in a centralized manner;
receiving a command from the user, the command relating to the operation of the at least one server; and
transmitting the command to the at least one server.

13. A system for managing a data center, comprising:
a control module for gathering data related to at least one server in the data center, the data being gathered from a plurality of sources; and
a user interface coupled to the control module for displaying the gathered data to a user in a centralized manner;
wherein the control module is further configured to receive a command from the user, the command relating to the operation of the at least one server, and to transmit the command to the at least one server.

14. The system of claim 13, wherein plurality of sources includes at least one of: a server check and application information module configured to perform fault checks on the at least one server, a baseboard management controller configured to generate statistics and graphs indicative of server usage, an asset center comprising an inventory of the data center, and a ticketing system configured to generate alerts indicative of abnormal events occurring in the data center.

15. The system of claim 14, wherein the server check and application information module is communicatively coupled to a database that stores historical server application information and reports.

16. The system of claim 15, wherein the information stored in the database comprises at lest one of: energy use calculations, energy savings calculations, server use data, server priority numbers, system administrator contacts, application user contacts, report capability information, server location information, cooling sector information, disk space usage data, incentive data, and server specification data.

17. The system of claim 13, further comprising:
a security module communicatively coupled to the control module and to the user interface for performing at least one of: user authentication, user authorization, least privilege, audit logging, data retention, data review, initiating timeouts, and generating warning messages.

18. The system of claim 13, wherein the control module is configured to issue the command on demand.

19. The system of claim 13, wherein the control module is configured to issue the command in accordance with a pre-defined schedule.

20. The system of claim 13, wherein the control module is configured to issue the command in an automated manner
